(19) United States
(12) Patent Application Publication
(10) Pub. No.: US 2022/0013127 A1
(43) Pub. Date: Jan. 13, 2022

(54) Electronic Speech to Text Court Reporting System For Generating Quick and Accurate Transcripts

(71) Applicant: Certified Electronic Reporting Transcription Systems, Inc., Aventura, FL (US)

(72) Inventors: Lee Goldstein, Aventura, FL (US); Blair Brekke, Naples, FL (US); Mikal Saltveit, Los Angeles, CA (US)

(21) Appl. No.: 17/352,040

(22) Filed: Jun. 18, 2021

Related U.S. Application Data
(63) Continuation-in-part of application No. 17/195,560, filed on Mar. 8, 2021.
(60) Provisional application No. 62/986,717, filed on Mar. 8, 2020.

(51) Int. Cl. G10L 15/26; G06F 40/169; G10L 15/22; G10L 25/57

(52) U.S. Cl. CPC G10L 15/26; G10L 25/57; G10L 15/22; G06F 40/169

(57) ABSTRACT

System for transcription of audio captured during in-person and/or remote (video-conferencing) events using speech to text (STT) technology. Each participant is associated with unique audio capturing device (microphone for in-person event; device utilized to partake in event (e.g., phone, computer) for remote event). Separate audio stream is captured for each participant and parameters about the participants are defined. Audio streams are synchronized with respect to each other for event. Bleeding of microphones is addressed by comparing equalized signal strengths and muting speech for microphones not having strongest signal strength. Synchronized audio streams are provided to STT engine that provides corresponding text back. Text is identified with stream it came from and time within event it occurred. System displays text in order based on event time and provides identification information and ability to edit/annotate. Operator edits/annotates translated text as required. Upon completion of editing/annotating a transcript may be automatically generated therefrom.

### BACKGROUND

The court reporting industry generates transcripts for the events (e.g., court proceedings, depositions) that the parties wish to have a record of. A court stenographer uses a court stenographer writing machine in order to capture the words spoken in a deposition or court hearing. The process utilizes the stenographer's mechanical perceptual/sensory motor skills, in that the sounds of the words are first entered through the stenographer's auditory system, and then processed down to the physical movements of the fingers. The sounds are entered into the machine, by typing on the keys in phonetics. The phonetics are transcribed/translated utilizing the stenographer's dictionary, which automatically converts the phonetics into words. Depending on how good the stenographer's perceptual motor skills are, coupled with how complete their dictionary is (built up over the years), will determine what amount and percentage of translates there will be (completion rate), and what the amount and percentage of un-translates there will be, in order to later manually edit/transcribe the un-translates into words.

However, there is a shortage of trained stenographers. Accordingly, digital reporters are being utilized to provide the transcriptions. The digital reporters are simply an audio tape recorder loaded onto a hard drive that is transcribed by an individual listening thereto after the fact. The accuracy of the transcriptions of these digital reporters currently do not compare to the accuracies of the court stenographers.

The global pandemic of 2020 limited in person events, including depositions and court proceedings, for a long period of time. While the events were initially delayed, eventually they resumed in remote fashion using a number of video and/or audio-conferencing applications including, but not limited to, Zoom, Microsoft Teams, GoToMeeting, Skype, WebEx and Vonage. If available, a court stenographer who was remote from all of the participants would capture the transcription of the event. Alternatively, the event was captured on a digital recorder for transcription after the fact.

What is needed is an alternative more accurate method and system for providing transcriptions of events that occur either in person or remotely.

### BRIEF DESCRIPTION OF DRAWINGS

The features and advantages of the various embodiments will become apparent from the following detailed description in which:

FIG. 1 illustrates a high-level system diagram of an example voice to text transcription system, according to one embodiment;

FIG. 2 illustrates a high-level flow diagram of an example voice to text transcription system, according to one embodiment;

FIG. 3 illustrates a high-level flow diagram of an example log-in sequence for an example voice to text transcription system, according to one embodiment;

FIG. 4 illustrates a high-level diagram showing bleeding issues associated with the use of multiple microphones for an in-person event, according to one embodiment;

FIG. 5A illustrates a selection of a microphone having strongest signal strength (loudest volume) without taking calibration of the microphones into account, according to one embodiment;

FIG. 5B illustrates selection of the microphone having strongest signal strength (loudest volume) taking calibration information into account, according to one embodiment;

FIGS. 6A-B illustrate a high-level flow diagram of an example in-person transcription process, according to one embodiment;

FIG. 7 illustrates a simple view of the process utilized to eliminate bleeding between microphones, according to one embodiment;

FIG. 8 illustrates an example display of the STT translation that an operator will see as the process occurs, according to one embodiment;

FIG. 9 illustrates an example transcript generated by STT translation corresponding closely to the translation displayed on the screen in FIG. 8, according to one embodiment;

FIG. 10 illustrates a high-level flow diagram for an example remote event transcription process, according to one embodiment; and

FIG. 11 illustrates a high-level flow diagram of an example invoicing sequence for an example voice to text transcription system, according to one embodiment.

### DETAILED DESCRIPTION

Speech to text software is becoming more common today. The software may be used, for example, to record notes or schedule items for an individual (e.g., Siri please add call mom Tues at 10 am to my schedule, Siri please add milk to my shopping list) or for dictation for school or work projects. The voice to text translation software may be located on a specific device (e.g., computer, tablet, smart phone) or a device may capture the voice and transmit it to a cloud-based voice to text system (such as Google speech to text) that performs the translation and sends the text back to the device. The accuracy of the various speech to text programs is getting better.

As such, the court reporting industry is attempting to utilize speech to text software to assist in the generation of transcripts due to the shortage of court stenographers and the accuracy issues associated with digital reporters. The use of video and/or audio-conferencing applications for remote events increases the desire to utilize speech to text software. There are issues associated with the use of speech to text as a substitute for court stenographers including, but not limited to, accurately capturing the speech of each of the participants, identifying which participants are speaking, how to handle the same speech being captured multiple times, how to easily edit the text provided from a speech to text program, and how to easily produce a transcript from the text that must be resolved in order to provide a speech to text transcription system that will be widely adopted for use.

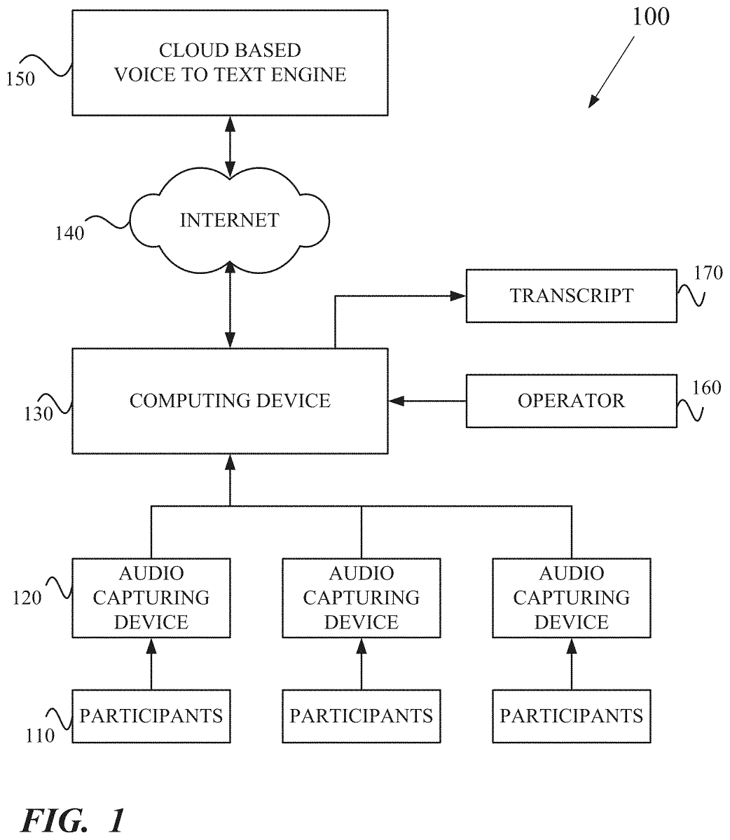

FIG. 1 illustrates a high-level system diagram of an example voice to text transcription system 100. The system 100 includes multiple audio capturing devices 120 associated with multiple persons 110 that may be speaking during the event, where the event may be in person or may be remote. If the event is in person, the audio capturing devices 120 may be microphones where one microphone is associated with each participant. The reason for the multiple microphones is to ensure that the speech of each participant is accurately captured and that the speech can automatically be associated with the appropriate participant based on the associated microphone that captured it. If the event is remote, each participant will be participating via their own device (e.g., computer, cell phone, tablet) and the video-conferencing platform (e.g., Zoom, Microsoft Teams, GoToMeeting, Skype, WebEx, Vonage) may capture a unique audio stream for each participant.

The audio from each audio capturing device 120 is provided to a computing device 130 as a separate audio stream. The computing device 130 may include a processor, a processor readable storage medium, a display, one or more user interfaces (e.g., mouse, keyboard), and one or more communications interfaces (e.g., to connect to Internet, to receive audio). The processor readable storage medium may have instructions stored therein that when executed cause the processor to function as a transcription program as will be described in more detail later.

The computing device 130 provides an operator 160 an ability to identify each of the streams. For example, the system may enable the operator 160 to identify a participant associated with each audio stream by name, title and/or what role they are performing (e.g., asking questions, answering questions). The computing device 130 stores the audio streams and the identities associated with the audio streams (e.g., identifies participant associated therewith), and prepares the audio streams for transmission to a cloud-based speech to text engine (e.g., Google Speech to Text) 150 via the Internet 140. Preparing the audio streams may include synchronizing the audio streams with one another (e.g., aligning in time).

For an in-person event where the transcript is to be captured in real time, the audio streams are provided to the speech to text engine (STT) engine 150 in real time (or close to real time). If the event was remote, the audio streams are obtained by the computing device 130 after the event has occurred and are then provided to the cloud-based engine 150 (the transcript is generated after the event).

The cloud-based engine 150 receives the plurality of audio streams associated with the event and processes the streams to generate blocks of text associated therewith. The blocks of text are based on the grouping of speech within the audio streams. The blocks of text are transmitted back to the computing device 130 via the Internet 150. The blocks of text are transmitted with an identification of the audio stream the speech was contained in and a time associated with the beginning of the translation of that block (e.g., 5:32 into event). The computing device 130 stores the blocks of text and presents the blocks of text on a screen in correct order based on the time associated therewith. The computing device 130 may also display the identification of the stream (e.g., participant name, identification of whether the text was a question or answer) with the associated text. The computing device 130 may utilize the time and stream identification included with the text block to provide a hyperlink to that point in the appropriate audio stream and present that hyperlink with the text block on the display. The hyperlink enables the operator 160 to listen to the audio stream at that point (synchronize the audio with the text). This can be used if the operator 160 is unsure if the text presented matches what was said and the operator wants to listen to the audio.

The computing device 130 may present tools for editing the text along with the text so that an operator 160 may make changes, record notes and/or flag possible errors thereto. The editing will be discussed in more detail later. Once edits are made to the text presented on the screen the edited text may be stored. According to one embodiment, the edited text may replace the text that was received from the STT engine 150.

The operator 160 may be able to make at least a portion of the necessary edits and/or annotations during a live in-person event. The operator 160 may look over the transcription provided on the screen after the live in-person event has occurred at which point they may finalize their edits and/or annotations. For remote events, where the audio streams are provided after the event has occurred, the operator 160 may pause the playback of the event to make necessary edits and/or annotations as the event is being replayed. Once all the edits and/or annotations are made, the computing device 130 may generate a transcript 170 in desired format therefrom. The computing device 130 knows the desired format of the transcript and how to present what is presented on the display in the appropriate format (e.g., appropriate line spacing, appropriate idents, manner in which party speaking is identified). The transcript 170 may be saved in various electronic formats (e.g., word, adobe, text, ascii) and may be printed.

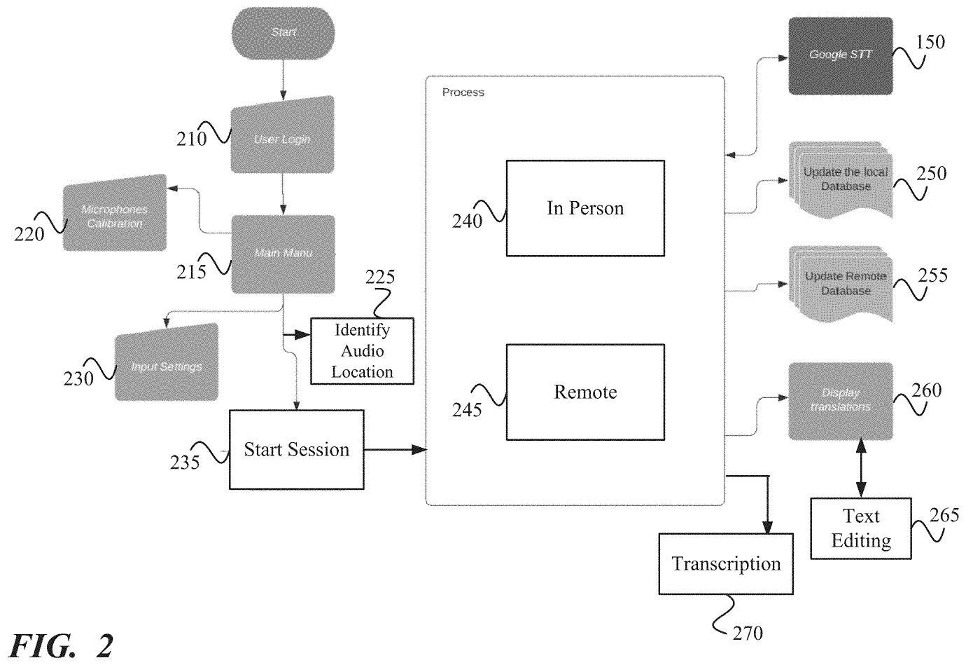

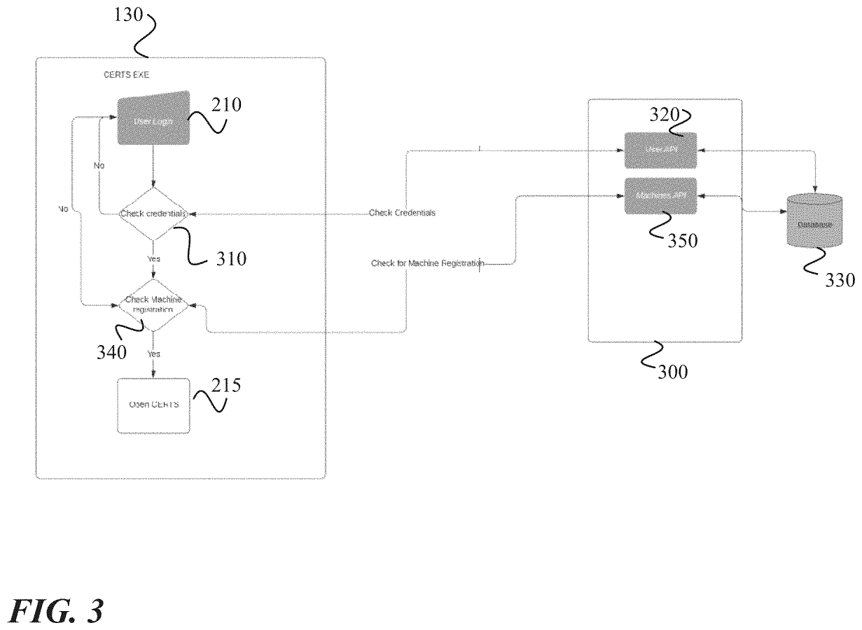

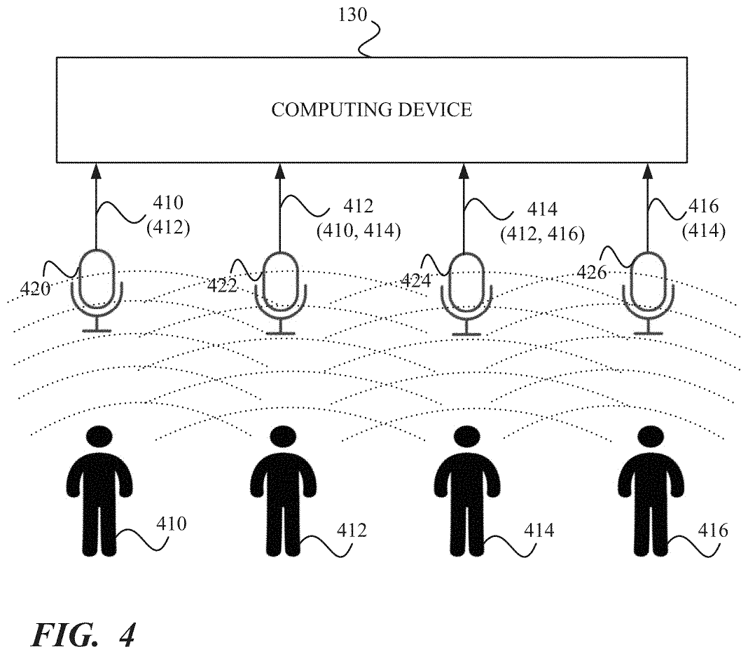

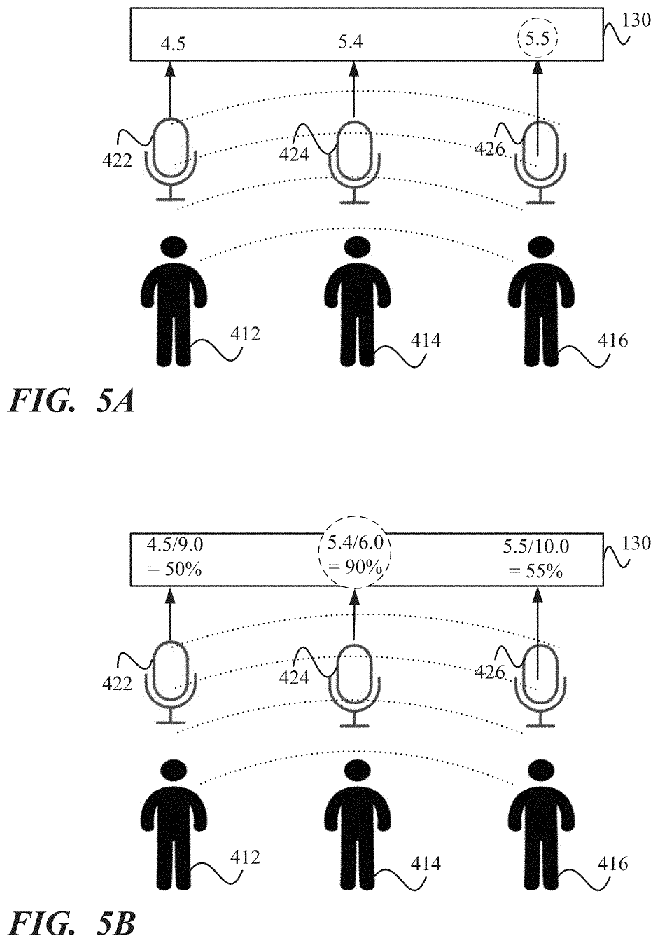

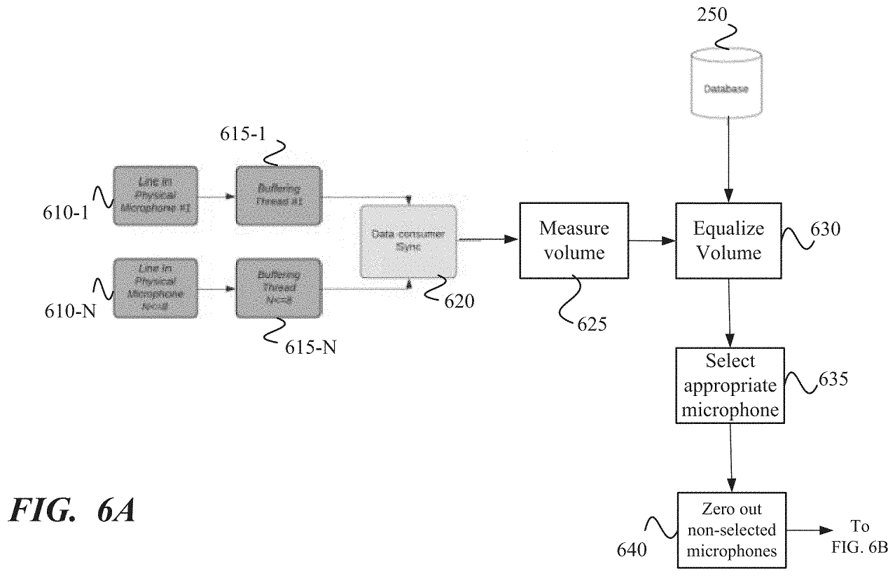

FIG. 2 illustrates a high-level flow diagram of an example voice to text transcription system 100. Once the transcription program is selected on the computing device 130, the user (is provided with a login screen where they enter the credentials they were provided (e.g., user name, password). The login process 240 entails communications between the computing device 130 and a server 300 associated with the system (will be discussed in more detail with regard to FIG. 3). The information regarding valid users and valid computing devices may be stored in a remote database 255. Once the login is successful, the operator 160 is provided with a main screen 215 that provides them with a plurality of options for how to procced. For example, the operator 160 may select what type of transcription event they would like to partake in (e.g., in-person event, remote event using a video conferencing application). If an in-person event is elected, the operator 160 may capture calibration information for each of the microphones that will be utilized 220. The calibration information may be the recording of the signal strength (volume) of each microphone with just the associated participant speaking in as quiet as an atmosphere as possible. This baseline signal strength for each microphone can be utilized to equalize the signal strength of each microphone. The reason that the calibration information 220 is important will be discussed in more detail with respect to FIGS. 4 and 5A-B.

If a remote event (e.g., event conducted via video conferencing application) is selected, locations for the audio streams associated with the event may be defined so that the system can retrieve the audio streams 225. For either an in person event or a remote event, input settings may be defined 230. The input settings may include identifying the number of participants participating in the event (e.g., number of microphones for in person event, number of saved audio streams for remote event). Each microphone (for in person events) or saved audio stream (for remote events) utilized for the event may be identified as being associated with a participant. The participants may be identified by name, position (e.g., attorney, witness), party (e.g., plaintiff, defendant) and/or what role they are performing (e.g., asking questions, answering questions).

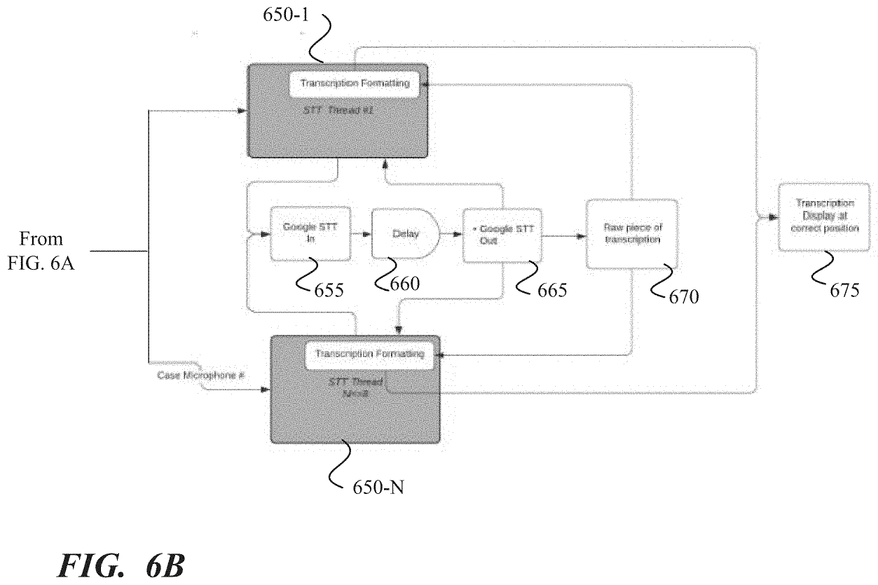

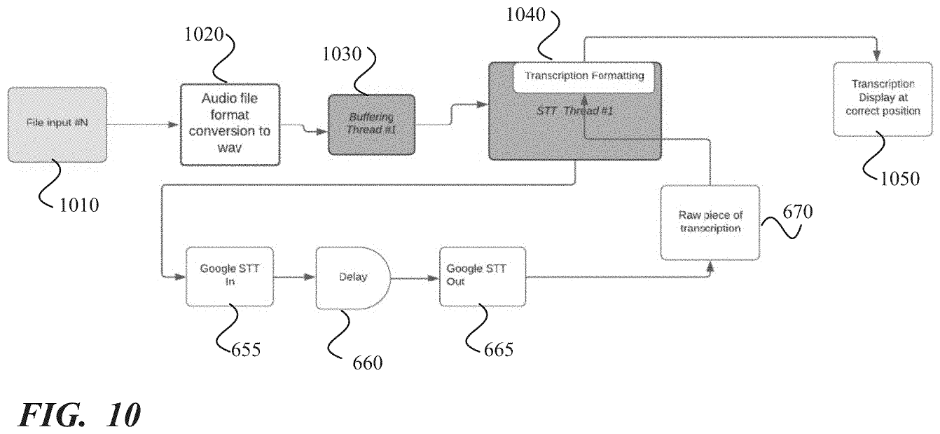

After the appropriate data has been defined an STT session may be started 235. The session includes utilizing the appropriate process (e.g., in person 240, remote 245). Each process may be unique in how it prepares the speech captured to be processed by the STT engine 150 (the in person process will be described in more detail with respect to FIGS. 6A-B and the remote process will be described in more detail with regard to FIG. 10). The audio streams captured by the microphones for an in person event may be stored locally 250 on the computing device 130. The STT engine 150 receives the various audio streams in alignment with one another from the appropriate process (e.g., 240, 245) and processes the audio streams and returns chunks of text back to the appropriate process (e.g., 240, 245) running on the computing device 130. The chunks of text may be defined by time in the event and an identification for the audio stream. The chunks of text may also be stored locally 250 on the computing device 130. The STT engine 150 may store data associated with the session in the remote database 255. The information stored may include amount of time the STT engine was active, number of streams, length of streams, number of words translated or he like. This information may be utilized for billing purposes.

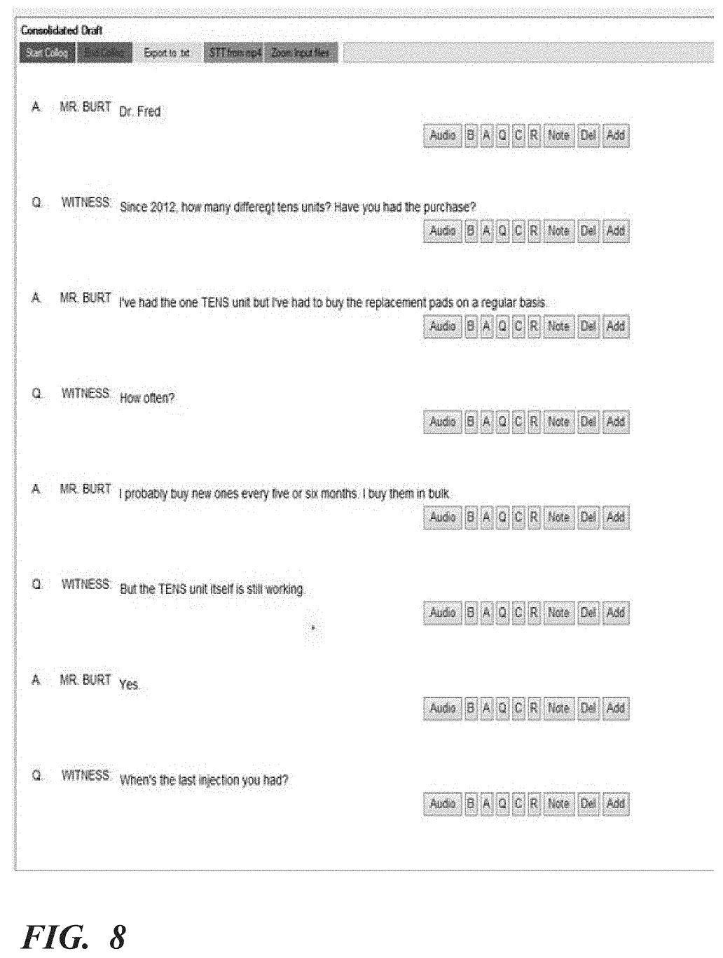

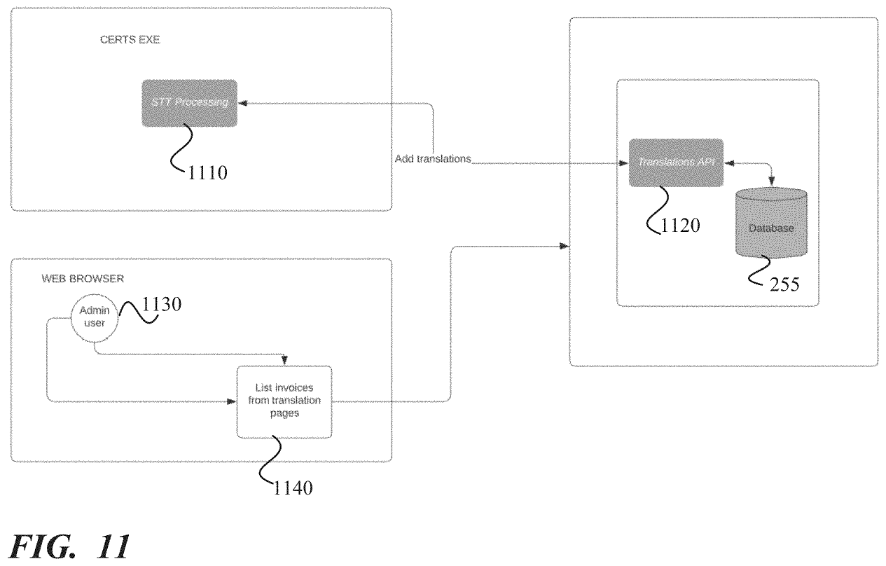

The chunks of text are presented on the display 260 based on time within the event and are identified by participant in some fashion (the presentation of the transcription on the display will be discussed in more detail with respect to FIG. 8). The appropriate process may also link each chunk of text to an appropriate point in an associated audio stream and create a link thereto and present that link on the display so that the operator can listen to the audio associated with the chunk of text presented. The appropriate process may also provide some editing and/or annotation tools on the display so that the operator can edit and/or annotate the text that is displayed 265. The edits to the text are stored locally 250. After all edits/annotations are completed the computing device may generate a transcript 270 based on the chunks of text presented on the screen and the edits/annotations thereto, the identification information for each audio stream and defined rules about the presentation of the transcript. Parameters about the transcript generated (e.g., number or pages, number of words, number or printed copies) may be stored in the remote database 255 for invoicing purposes (described in more detail with regard to FIG. 11).

FIG. 3 illustrates a high-level flow diagram of an example log-in sequence for an example voice to text transcription system 100. In order to use the system 100, a user (operator) 160 must have login credentials and may also require the computing device 130 they are utilizing to be registered. This double authentication ensures that only appropriate users and their identified computing device 130 can utilize the system. A user of the computing device 130 initiates a login sequence 210 at which point they enter their login credentials 310. The login credentials are then transmitted to the server 300. The credentials are received and processed by a user application program interface (API) 320 which queries a remote database 330 that has registered users information maintained therein. If the users credentials are not validated (310 No), the login process is denied and the process starts again. If the users credentials are validated (310 Yes), the computing device 130 transmits an identification (e.g., MAC address) 340 for the computing device 130 to a machines API 350 which queries the database 330 that has registered machines information maintained therein. If the machines credentials are not validated (340 No), the login process is denied and the process starts again. If the machines credentials are validated (340 Yes), the transcription program is opened 215.

For in-person events, it is possible that the individual microphones pick up speech from more than a single participant. That is, a microphone may pick up the speech for the participant associated therewith as well as the speech from other participants (especially those in close proximity thereto). This is known as microphone bleeding. Microphone bleeding needs to be accounted for so that the same speech is not translated to text multiple times and associated with different participants.

FIG. 4 illustrates a high-level diagram showing bleeding issues associated with the use of multiple microphones for an in-person event. As illustrated, there are four participants 412, 414, 416, 418 at the event who may be speaking. Each participant has a microphone 422, 424, 426, 428 associated therewith (placed in close proximity thereto). As can be seen, the speech from each participant 412, 414, 416, 418 radiates out therefrom and may be picked up by the associated microphone as well as other microphones associated with other participants that may be within range. For example, the speech of participant 412 may be picked up by the associated microphone 422 as well as microphone 424 (to the right thereof); the speech of participant 414 may be picked up by the associated microphone 424 as well as microphones 422, 426 (on either side thereof); the speech of participant 416 may be picked up by the associated microphone 426 as well as microphones 424, 428 (on either side thereof); and the speech of participant 418 may be picked up by the associated microphone 428 as well as microphone 426 (to the left thereof). As such, each microphone may have received speech associated with more than the corresponding participant and may transmit the non-associated speech of various other participants to the computing device 130 as part of its audio stream.

As one would expect, bleeding between microphones could create a major problem in the translations, as the same speech could be provided from multiple sources. As such, the translations may be duplicative (provide overlapping text). Furthermore, the speech captured may vary between microphones (e.g., one microphone may not capture all of the words, one microphone may not clearly capture all the words) so that the text provided back from the STT engine could vary. Furthermore, while the audio streams may be synchronized it is possible that the same speech detected by different microphones may be slightly out of alignment.

What is needed is a manner to avoid the bleeding where only the appropriate microphone provides the speech to the STT engine. In order to select the appropriate microphone, you will want to compare the signal strength (e.g., volume level) of each microphones. However, the microphones may not be equally calibrated and the maximum volume capable of being detected by each microphone may vary. As such, simply looking at volume may result in selecting an inappropriate microphone.

FIG. 5A illustrates a selection of a microphone having strongest signal strength (e.g., loudest volume) without taking calibration of the microphones into account. The participant 414 is speaking and the speech is detected by the associated microphone 424 as well as microphone 422, 426. The signal strength of the speech detected by each microphone is compared and the microphone 426 is selected without calibration as that signal strength is determined to be slightly higher than the associated microphone 424.

FIG. 5B illustrates the example of FIG. 5A where the calibration information is utilized to determine which microphone has the strongest signal strength. In this example, the detected signal strength is divided by the baseline signal strength to determine the signal having a current signal strength that is the highest percentage of the baseline value. In this case, the associated microphone 424 is selected as the signal strength was 90% of the baseline signal strength. It should be noted that the numbers utilized in these examples are simply numbers selected for comparison sake and are not necessarily an indication of actual signal strength numbers. Furthermore, determining the percentage of the baseline signal strength is simply one manner in which the signal strength of the microphones can be equalized based on the calibration information.

FIGS. 6A-B illustrate a flow diagram for an in-person event process 240. The audio captured for each microphone associated with the session 610-1 through 610-N is provided to the computing system. The audio received from each microphone is buffered 615-1 through 615-N. Each of the buffered audio streams are then synchronized (aligned in time) 620. The volume of each buffer is detected 625 and is then equalized based on the calibration data previously captured 630. The microphone associated with the buffer having the loudest equalized volume is selected as the active microphone 635. The volume for the non-selected buffers is zeroed out so that no speech is detectable 640.

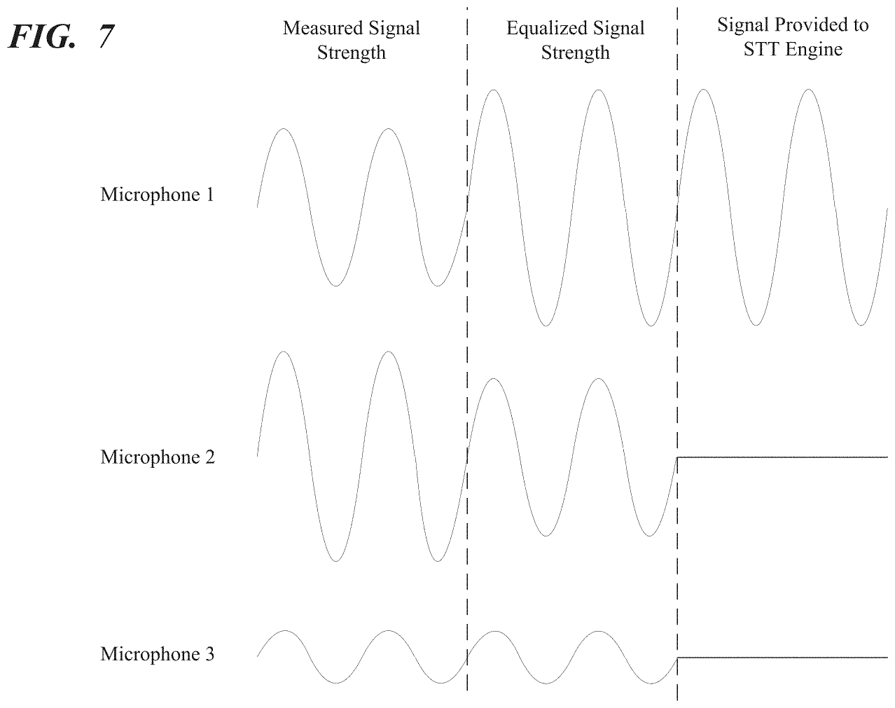

FIG. 7 illustrates a simple view of the process utilized to eliminate bleeding between microphones. As illustrated three microphones are utilized to capture the speech of three participants during a live event. The capturing of the speech is shown in simplistic form as a sign wave where the amplitude of the sine wave is the volume. A participant associated with the first microphone is speaking but the speech is detected by all three microphones. As illustrated, the measured signal strength is greater for microphone 2 even though the participant is associated with microphone 1. The signal strengths are then equalized based on calibration data that was previously captured for each of the microphones. As illustrated, once equalized, the signal strength for microphone 1 is determined to be the strongest. Accordingly microphone 1 is selected as the active microphone and the volume for the other microphones is zeroed out so that no speech is provided for these microphones during that period. This process continues for each buffered portion of audio for the event.

Referring back to FIG. 6B, each of the buffers (selected and non-selected) is then prepared for transmission as a unique thread to the STT engine 650-1 through 650-N. The STT engine receives the speech from each thread as input 650, the computing device experiences a delay while the STT engine is processing 655, and then the STT engine outputs the resulting text 660. The raw text received 670 is routed back for processing by the appropriate thread 650-1 through 650-N. The processing for each thread includes storing the text received in a local database, using the timing information associated with the text to identify the portion of the associated audio and providing a link to that portion of the audio and including the identification information for each microphone. Based on the processing of each thread the transcription is displayed on the screen in the correct order based on the time within the event 675. As previously noted, the display may include editing and annotation tools.

FIG. 8 illustrates an example display of the STT translation that an operator will see as the process occurs. As illustrated, the text is provided in order based on the time identified for when the translation started (e.g., how far into the event). The text appears with annotations associated with whether the text is deemed to be a question or an answer, and also who is speaking, based on the identification preprogrammed for each microphone. It should be noted that the identification of the person speaking for each block of text may not appear in the transcript and thus is additional information provided to assist the operator. A menu is provided with each block of text that enables the operator to make edits and/or annotations to what is provided on the screen based on the translation provided by the STT engine.

The menu may provide a link to the associated audio for this block of text so that if the operator believes there is an issue with the translation, they can hit the button and listen to the associated audio. It should be noted that this may be done after the event, or during a break in the event, as doing during the event while addition dialogue is occurring may be difficult. The B button may be to identify when a certain party starts speaking and this may be utilized for the generation of the transcript where rather than include the speakers name with each block of text the speaker is simply identified at the beginning of their dialogue. The Q and A buttons are to identify whether the dialogue is associated with an answer or a question. Based on the parameters defined about each microphone this should already be identified, but there may be situations where it is not identified or is identified inaccurately. The C button is to indent colloquy which is dialogue that is not associated with a question or answer and may be dialogue associated with objections, clarification or confidential information. The identification of colloquy is important for the generation of the transcript as the text associated with colloquy is typically indented. It should be noted that court stenographers use similar keys to identify question, answer and colloquy.

The menu may also include an R button to identify text that the operator wants to come back and review later. This may be used by the operator when, for example, they believe that there is some type of error in the translation provided but do not want to hold up the event and plan to come back and review at a later point in time. A notes button may be utilized to add notes that the operator can use at a later point in time. An add button can be utilized to add text associated with speech that, for example, was not detected. A delete button can be utilized to, for example, delete text that should not have been captured or that was inaccurately captured.

It should be noted that the editing/annotating tools are not limited to the ones illustrated, being identified as they are, or to the location or manner in which they are presented. Rather, the use, identification and presentation of different editing/annotating tools to enable an operator to edit/annotate a STT transcript are within the current scope.

Once the operator is done editing/annotating the translations provided on the display the operator may generate the transcript therefrom. The system may utilize the rules defined for formatting, etc. of transcripts and the annotations made directly by the system (e.g., indentation of answer, question) and annotations made by the operation (e.g., identification of colloquy, identification of party responsible for portion of event) to produce the transcript. The transcript may be electronically produced in one or more formats and may also be printed.

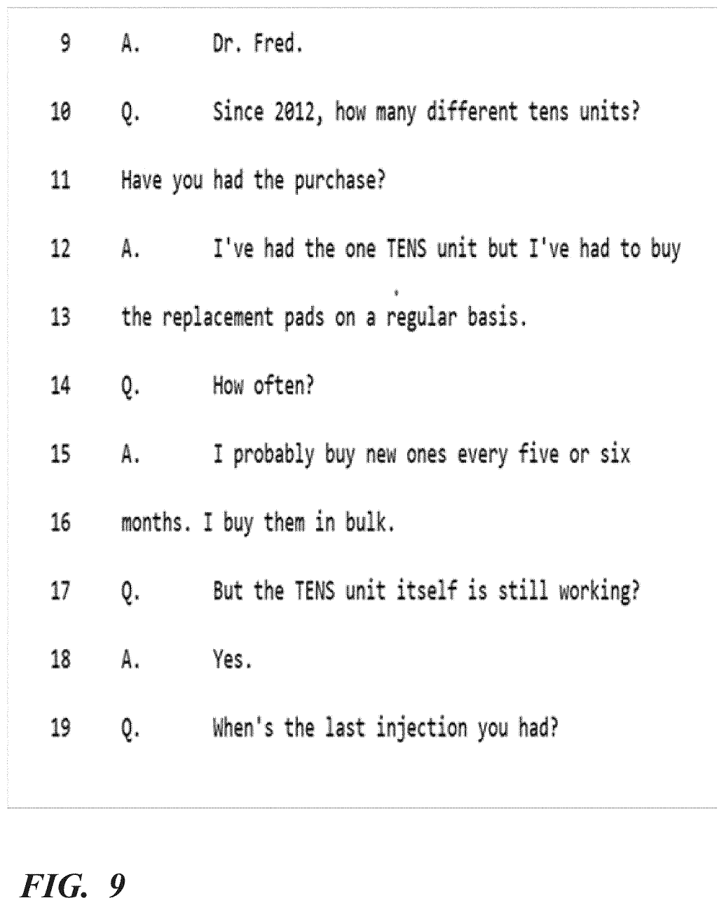

FIG. 9 illustrates an example transcript generated by STT translation corresponding closely to the translation displayed on the screen in FIG. 8. As noted, the participants name is not displayed prior to each question or answer. While not illustrated in FIG. 9, the transcript may identify, for example, the party asking questions during a certain portion of the event. For example, prior to direct examination of a witness the attorney asking the questions may be identified (e.g., By Mr. Smith) and then prior to cross examination of a witness the attorney asking the questions may be identified (e.g., By Ms. Jones). Those familiar with transcripts will understand the appearance, formatting, etc. of transcripts.

FIG. 10 illustrates a high-level flow diagram for an example remote event process 250. For the remote event that occurred using a video-conferencing platform including, but not limited to, Zoom, Microsoft Teams, GoToMeeting, Skype, WebEx and Vonage, a unique audio stream may be utilized for each participant. The unique audio streams may be stored locally on the computing device 130 and the operator 160 may provide the system with a link to the audio stream 1010. Initially the audio stream is converted from the form it is in (e.g., MP4) into a form that the STT engine requires to covert the speech to text (e.g., way) 1020. The audio stream is then buffered 1030. The buffered audio stream is then prepared for transmission to the STT engine 1040. The STT engine receives the speech for the audio thread as input 650, the computing device experiences a delay while the STT engine is processing 655, and then the STT engine outputs the resulting text 660. The raw text received 670 is routed back for processing 1040. The processing includes storing the text received in a local database, using the timing information associated with the text to identify the portion of the associated audio and providing a link to that portion of the audio and including the identification information for each microphone. Based on the processing the transcription is displayed on the screen in the correct order based on the time within the event 1050. As previously noted, the display may include editing and annotation tools. It should be noted that this same process is repeated for each thread associated with the remote event and that the plurality of threads are organized in time sequence for display on the screen. As each individual audio stream should only contain the audio for that specific participant there is no need to detect signal strength, equalize signal strength and select strongest signal as is done with the in-person event. Furthermore, as audio streams are being provided after the event has occurred the streams do not need to be buffered and transmitted simultaneously as long as they are synchronized with respect to one another as the time from beginning of event is how translations are ordered on the display.

The presentation of the translations on the display and the transcript generated therefrom are substantially the same for the remote version as the in-person version.

FIG. 11 illustrates a high-level flow diagram of an example invoicing sequence for an example voice to text transcription system 100. When the system is utilized to generate a transcript the STT program 1110 utilizes a translation API 1120 to store parameters about the transcript generated in the remote database 255. The parameters captured about the transcript may include number of pages, number of words, and length of event. When it is time to invoice for the transcript, an administrator user 1130 may utilize a web browser to generate an invoice for the event 1140. The invoice may be generated by accessing the database 255 to retrieve the necessary parameters that are utilized to generate the invoice. For example, if the invoice is based on the number of pages the number of pages may be retrieved from the database 255 and the appropriate price per page may be applied.

Although the disclosure has been illustrated by reference to specific embodiments, it will be apparent that the disclosure is not limited thereto as various changes and modifications may be made thereto without departing from the scope. The various embodiments are intended to be protected broadly within the spirit and scope of the appended claims.

1. An electronic system for transcription of audio comprising
a plurality of audio capturing devices; and
a computing device including a processor and computer readable memory device storing instructions that when executed by the processor cause the processor to
receive and store audio streams from the plurality of audio capturing devices;
provide the audio streams to a speech to text (STT) engine;
receive corresponding text from the STT engine, wherein the text includes identification of the audio stream it is from and time within event which it occurred;
display text in order; and
enable an operator to edit or annotate the text.

2. The system of claim 1, wherein the plurality of audio capturing devices are microphones.

3. The system of claim 1, wherein the plurality of audio capturing devices are provided by a video conferencing platform.

4. The system of claim 3, wherein the audio streams received from the video conferencing platform are configured in a first format while the STT engine requires audio streams to be provided in a second format, so the instructions when executed by the processor cause the processor to convert the audio streams from the first format to the second format.

5. The system of claim 1, wherein the audio streams received from the plurality of audio capturing devices are synchronized.

6. The system of claim 1, wherein the instructions when executed by the processor cause the processor to define parameters for each audio stream.

7. The system of claim 6, wherein parameters include at least some subset of participant name, participant position, participant party and participant task.

8. The system of claim 6, wherein the instructions when executed by the processor cause the processor to automatically annotate parameters about the audio stream when the text is displayed.

9. The system of claim 1, wherein the instructions when executed by the processor cause the processor to identify a portion of an associated audio stream associated with text displayed and present a link to that portion of the audio so the audio can be replayed.

10. The system of claim 1, wherein the editing or annotating includes at least some subset of modify text, add text, delete text, annotate text as colloquy, annotate text as question, annotate text as answer, annotate text to define a new participant speaking, highlight need for review, and add notes.

11. The system of claim 2, wherein the instructions when executed by the processor cause the processor to collect calibration information for each of the microphones prior to initiating the event.

12. The system of claim 11, wherein the instructions when executed by the processor cause the processor to buffer the audio streams for each microphone, determine volume of the buffered audio streams, equalize the volumes based on the calibration information, select audio stream with loudest equalized volume and zero out volume for other audio streams and provide the selected and zeroed out audio streams to the STT engine.

13. The system of claim 1, wherein the instructions when executed by the processor cause the processor to automatically create a transcript from edited or annotated text displayed.

14. The system of claim 13, wherein the instructions when executed by the processor cause the processor to store information about the transcript generated, wherein the information is utilized to create an invoice for the transcript.

15. A method for generating a transcript utilizing speech to text, the method comprising
receiving a plurality of audio streams, wherein each audio stream is associated with a participant for an event;
providing the audio streams to a speech to text (STT) engine;
receiving corresponding text from the STT engine, wherein the text includes identification of the audio stream it is from and time within event which it occurred;
displaying text in order based on speech captured in the audio streams;
providing editing and annotating tools to enable an operator to edit or annotate the text; and
capture edits of annotations made by the operator.

16. The method of claim 15, wherein the plurality of audio streams are received from a plurality of microphones, and further comprising
collecting calibration information for each of the microphones prior to initiating the event;
determining volume of the buffered audio streams;
equalizing the volumes based on the calibration information;
selecting the audio stream with loudest equalized volume and zeroing out volume for other audio streams; and
providing the selected and zeroed out audio streams to the STT engine.

17. The method of claim 15, wherein the plurality of audio streams are received from a video conferencing platform, wherein the audio streams received from the video conferencing platform are configured in a first format while the STT engine requires audio streams to be provided in a second format, and further comprising converting the audio streams from the first format to the second format.

18. The method of claim 15, further comprising
defining parameters for each audio stream; and
automatically annotating parameters about the audio stream when the text is displayed.

19. The method of claim 15, further comprising
identifying a portion of an associated audio stream associated with text displayed; and
presenting a link to that portion of the audio so the audio can be replayed.

20. The method of claim 15, further comprising automatically creating a transcript from edited or annotated text displayed.
